(19) United States
(12) Patent Application Publication
(10) Pub. No.: US 2003/0032701 A1
(43) Pub. Date: Feb. 13, 2003

(54) Refractory compositions

(76) Inventor: Michael John Gough, Staffordshire (GB)

Correspondence Address: Nixon & Vanderhye, 8th Floor, 1100 North Glebe Road, Arlington, VA, 22201-4714, US

(21) Appl. No.: 10/204,212

(22) PCT Filed: Feb. 14, 2001
(86) PCT No.: PCT/GB01/00598

(30) Foreign Application Priority Data
Feb. 19, 2000 (GB) 0003857.0

(51) Int. Cl. C08J 9/32

(52) U.S. Cl. 523/218

(57) ABSTRACT

An insulating refractory composition which is fiber free and comprises a lightweight refractory filler of tamped bulk density no greater than 0.4 g/cc, hollow refractory microspheres and a binder, the binder being water-based or curable at about 100° C. or below, the composition being curable by microwaves and having a cured density of less than 0.45 g/cc.

This invention relates to refractory compositions, particularly but not exclusively for use in the manufacture of feeder sleeves used in the casting of molten metal.

When molten metal is cast into a mould it solidifies on cooling and will shrink in volume as it solidifies. It is, therefore, conventional practice to use a feeder sleeve leading into the mould so that the molten metal in the feeder sleeve can feed into the mould as the solidifying metal in the mould shrinks. Shrinkage defects in the moulded product can thereby be avoided.

Feeder sleeves may, as is well known, be made of exothermic and/or heat insulating compositions to improve their effectiveness. Similar compositions may be used in the form of, e.g. boards or discs, to be positioned on top of open riser sleeves or as steelworks ingot linings and the invention relates also to compositions for such products.

Conventionally, these products have been made by slurry forming techniques or by ramming or core shooting an appropriate composition into a suitably shaped mould. The composition in its mould may then be cured, depending on its composition, by a chemical cold-curing process. Alternatively, it may be cured by heating in an oven, usually of the hot-air circulating type, in which case it may need first to be removed from its mould.

Conventionally used refractory compositions for these purposes have included refractory fibres, inorganic fillers and binders and, in the case of insulating compositions, with which the present invention is particularly concerned, there has been a desire in the art to reduce the density of the compositions, thereby increasing their thermal insulation efficiency and reducing unit raw material cost. In addition to reducing density, there is also a need to introduce fibre-free compositions for reasons of health and safety.

However, it has proved difficult to obtain significant reductions in the density of the compositions while retaining adequate strength. Thus there is a restricted choice of refractory filler materials that can adequately reduce composition density as many lightweight fillers are too porous, physically weak, environmentally unfriendly or have poor refractoriness. Moreover, even with a suitable filler, density reduction of a significant amount can also lead to a dramatic reduction in the green strength of the shaped composition. Damage to or collapse of the shaped composition can easily occur and the problem is not readily resolved merely by the addition of additional binder material. Generally speaking, the addition of further binders used to improve green strength becomes less effective, and even ineffective, as density falls.

The green strength problem can be such that formed shapes of low density compositions can even be damaged by the hot air circulation of an oven.

It is, therefore, an object of the present invention to provide an insulating refractory composition of relatively low density and a means of safely converting a shaped product of that composition into a fully cured satisfactory final product.

Accordingly, in one aspect the invention provides an insulating refractory composition which is fibre free and comprises a lightweight refractory filler of tamped bulk density no greater than 0.4 g/cc, hollow refractory microspheres and a binder, the binder being water-based or curable at about 100° C. or below, the composition being curable by microwaves and having a cured density of less than 0.45 g/cc.

Preferably the density of the cured composition is less than 0.40 g/cc.

The lightweight refractory filler is preferably perlite, which may have a tamped bulk density e.g. in the range 0.1 to 0.2 g/cc, but other lightweight fillers, e.g. calcined diatomite, expanded vermiculite and Kiesleguhr may be used.

By “tamped bulk density” herein is meant the density measured following the well known standard test in which a 100 cc cylinder filled with the material is tamped by a sequence of controlled droppings of it from a set height.

The lightweight refractory filler is preferably used in the composition prior to curing in an amount of up to 25 percent by weight, preferably from 1.0 to 15 percent by weight.

The hollow refractory microspheres may be cenospheres, which may have, for example, a tamped bulk density of about 0.45 g/cc and are suitable for compositions to be used with molten aluminium but other microspheres, e.g. of alumina or alumina-silica may be used, particularly for compositions for use with molten iron and steel.

The microspheres are preferably present in the uncured composition in an amount of up to 95 percent by weight, preferably from 39 to 87 percent by weight.

As indicated above the binder should be water-based or it may be a resin, e.g. UF resin, which is curable at about 100° C. or less and hence can be cured in a microwave oven. The water-based binder may be an organic binder, e.g. acrylic resin emulsions, vinyl acetate emulsions, ethylene-vinyl acetate emulsions and vinyl acetate-acrylic ester copolymer emulsions. It is preferably of low viscosity, film-forming at room temperature and with a high film strength.

The binder or binders is/are preferably present in the uncured composition in an amount of up to 32 percent by weight, preferably from 4 to 22 percent by weight.

The total liquid content of the uncured composition, which includes water or other liquid contained in the binder(s), should preferably not exceed 20 percent by weight and preferably should be in the range from 2 to 17 percent by weight.

The inventor of the present invention has surprisingly found that shaped compositions of the invention can be successfully cured in a microwave oven and that these low density compositions are not damaged during the curing process, as they are more likely to be during conventional curing in a hot air circulating oven. Moreover, the cured products have been found to have excellent insulation properties while retaining strength and refractoriness comparable to conventional products. For example feeder sleeves of compressive strengths of greater than 20 kg/sq.cm may be made by the invention.

Accordingly, in another aspect the invention provides a method of making a cured, shaped product of refractory composition in which a fibre-free composition comprising a lightweight refractory filler, hollow refractory microspheres and a binder which is water based or curable at 100° C. or below is shaped to a green product and the green product is cured by microwaves.

It will be appreciated that the compositions should not contain elemental aluminium or other elemental metals in order that they be safely microwavable.

The cured shaped compositions should have a residual water content no higher than 0.5% by weight when they are to be used in contact with molten metal and this limit must be consistently reached in any drying process used. It has been found that it is consistently reached in the microwaving process without any need for a further, separate drying stage despite the fact that microwaves may only raise the temperature inside the shaped composition to about 90° C. to 100° C.

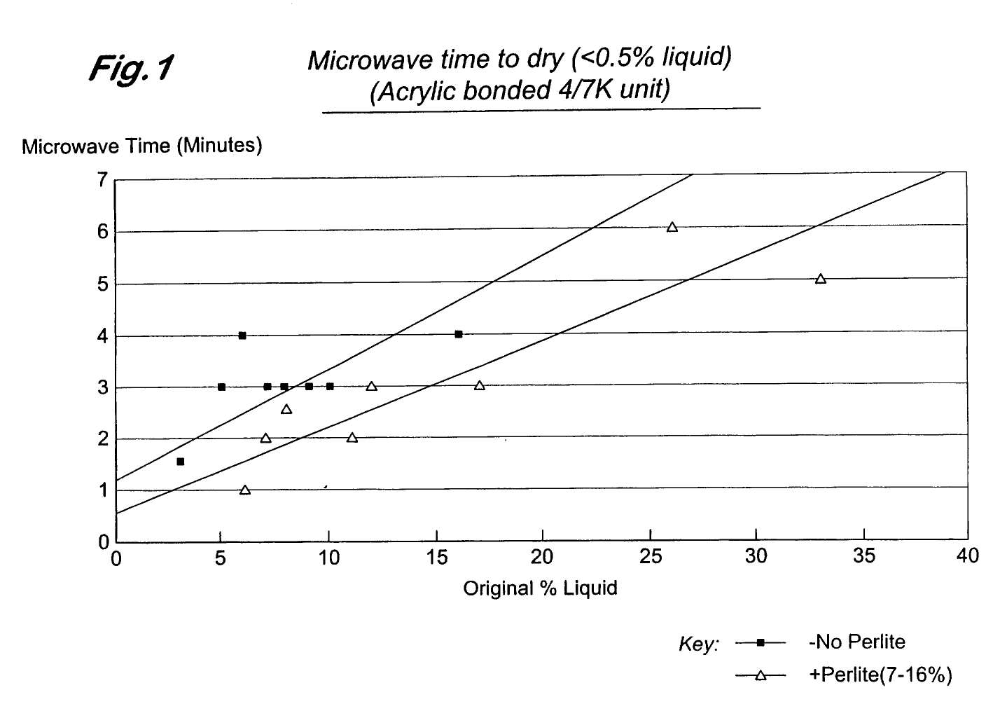

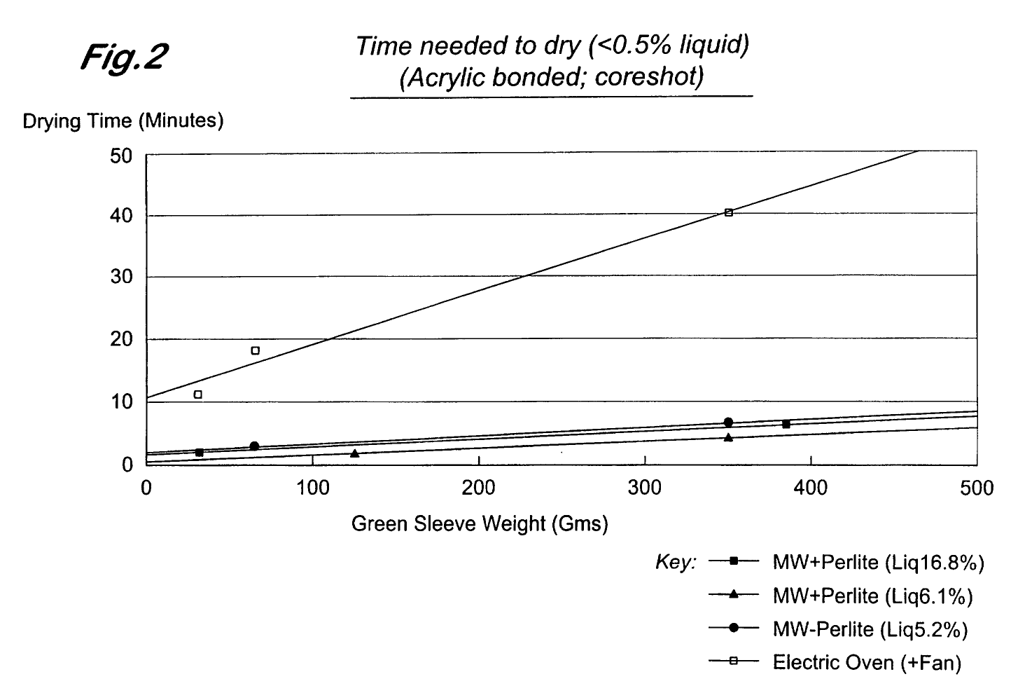

Clearly, the time and microwave power, which may be e.g. from 600 to 850 watts, needed to cure the shaped compositions will depend to a large extent on their mass and section thickness and the numbers of shaped units being cured at one time. Individual products of wall section 9 to 20 mm can be cured in less than 10 minutes, typically from 1 to 5 minutes. The inclusion of the lightweight filler in the composition of the invention surprisingly reduces microwave curing times—see FIG. 1. Moreover, as is shown in FIG. 2, the effect of increasing mass on drying times is less for the present invention than for conventional curing in an electric fan oven.

As indicated above, the composition of the invention may be shaped prior to curing by any convenient means, e.g. ramming, core-shooting or jolt/squeeze techniques. Because the compositions can be cured while within the mould that shapes them, provided that the mould is sufficiently porous to enable escape of steam, products of accurate shape and dimensions can be achieved.

Cured shaped compositions of the invention can be formulated to be suitable for use with molten aluminium and its alloys, copper and iron and their alloys and with steel and its alloys. Examples of composition for these various uses are given in the Table below in which all parts are by weight.

TABLE

| | Aluminium | Copper and | Steel |
|---|---|---|---|
| | Alloys | Iron Alloys | Alloys |
| | % | % | % |
| Hollow Alumina Microspheres | — | — | 20-22 |
| (100% Alumina; BD | | | |
| 0.25-0.4 g/cc) | | | |
| Hollow Alumina - Silica | — | 56-95 | 47-75 |
| Microspheres | | | |
| (43.3% Alumina; BD | | | |
| 0.3-0.45 g/cc) | | | |
| Fly Ash Floaters - Cenospheres | 39-93 | — | — |
| (26-30% Alumina; BD | | | |
| 0.3-0.45 g/cc) | | | |
| Expanded Perlite or Calcined | 2-25 | 1-15 | 1-8 |
| Diatomite | | | |
| Acrylic Resin Emulsion (50% | 5-20 | 4-15 | 4-15 |
| solids) | | | |
| BASF DS 3438X | | | |
| Sodium Silicate (Solids) | 0-5 | 0-3 | 0-2 |
| Urea Formaldehyde Resin | 0-1 | 0-1 | 0-1 |
| (solids) | | | |
| Water | 0-10 | 0-5 | 0-5 |
| Refractoriness Ratio:- | Not | Not | 55.50% |
| Alumina/(Alumina + | applicable | applicable | to |
| Silica) × 100% | to aluminium. | to copper | 55.54% |
| | | and iron. | |

Dyes in an amount of up to, say, 0.3% by weight may be included in the compositions. Thus a different coloured dye may be used to denote compositions for use with different molten metals. By this means a product intended for use, for example, with molten aluminium should not be used in error with molten iron or steel.

Coal dust, e.g. in an amount of from 0.5 to 6.0% by weight, may usefully be added to compositions to be used with molten iron in order to provide a reducing atmosphere.

Sleeves and boards or discs made according to the invention are eminently suitable for use in the feeder cavities of moulds, e.g. sand moulds, for molten metal and, in another aspect, the invention extends to such moulds including a cured, shaped refractory composition of the invention.

The invention provides a number of advantages over conventional compositions and methods of curing them.

Microwave oven temperatures are more consistently controllable compared with conventional ovens, which may be prone to high and low temperature zones.

The microwave curing step enables the water content to be readily and consistently reduced quickly to a safe level. No further drying step is needed.

It enables lower density products to be cured with reduced risk of damage.

Lower oven drying temperatures are used hence reducing fire risk, e.g. ignition of organic binders in the composition.

There is a cleaner environment at the curing/drying stage as only steam is evolved. No scrubbers are needed, as they may be, for example, in conventional sleeve manufacture using PF resin binders.

The cured products can be handled and packed more quickly. Some conventionally-cured sleeves require a cooling period before they can be handled safely.

The compositions of the invention can be used to make products, e.g. sleeves, that are fibre-free (both organic and inorganic) and may also be phenol free and fluoride free. The latter advantage means that there is no mould sand contamination from sleeve residues. The products can have a low organic content, which leads to less chance of carbon pick up on low carbon steels and, being free of organic fibre, the products do not produce any acrid smoke or smell when cast with aluminium, due to “charring” of such fibres.

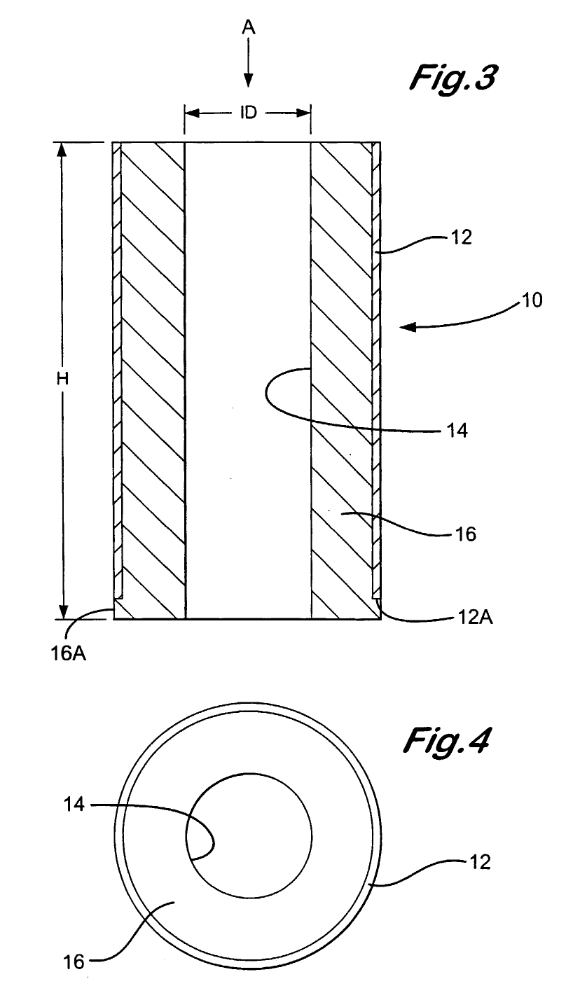

Embodiments of the invention are further described by way of example only with reference to the accompanying FIGS. 3 to 5 of the drawings in which:

FIG. 3 is a longitudinal sectional view of a temporary mould in which to make a sleeve of the invention;

FIG. 4 is a plan view in the direction of arrow A of FIG. 3; and

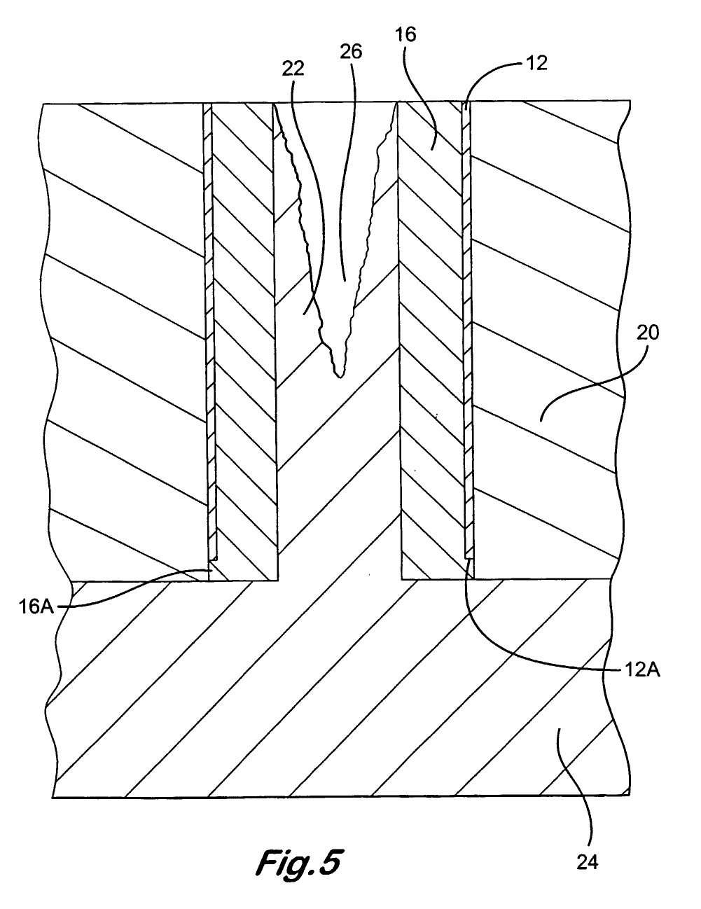

FIG. 5 is a sectional view showing the sleeve of FIGS. 3 and 4 in use in a sand mould.

In FIGS. 3 and 4 is shown a temporary mould 10 for a feeder sleeve. The mould is a tube 12 of paper or card or cardboard of wall thickness up to 1.5 mm having a hollow core 14 defining a cylindrical mould cavity. Into the cavity has been rammed or core shot an annular filling 16 of a refractory composition according to the invention.

Filling 16 is moulded to extend a little, e.g. 3 to 5 mm, beyond one end 12A of tube 12 to form a collar 16A over end 12A for a purpose to be described below with reference to FIG. 5.

A range of such temporary moulds can be used to make different size sleeves, i.e. length H can be 6 inches (152 mm) and internal diameter ID from 3 inches (76 mm) to 6 inches (152 mm) and length H can be 12 inches (305 mm) and internal diameter ID from 2 inches (51 mm) to 12 inches (305 mm).

The filled mould 10 can be placed in a microwave oven with the core 14 preferably removed and the shaped composition cured to dryness without damage to the temporary mould, which would char or burn in a conventional oven drying process. The mould can be removed from the oven immediately after the curing step and the cured sleeve may be removed immediately from its temporary mould or retained in it until needed for use or retained in it during the actual casting process.

In FIG. 5 is shown the tube 12 containing the cured sleeve filling 16, and from which the mould core 14 had been removed prior to the microwaving step, positioned in a sand mould 20 immediately above a mould cavity 24. The tube/sleeve has been rammed in situ into moulding sand in a conventional manner to be a tight fit in the correspondingly sized cavity thus formed in the sand mould. The lower end of the tube 12 is end 12A which does not quite reach the mould cavity due to the extension of the collar filling 16A. By this means, molten metal 22, which rises up into the sleeve as the sand mould is filled, does not come into contact with the end 12A of the tube 12.

As can be seen in FIG. 5, the mould has been filled with molten metal, which is starting to shrink as it cools, this being indicated by the depression 26 formed in the molten metal within the sleeve as it sinks to replace the shrinkage.

The use of the temporary mould enables compositions to be used that otherwise might not have sufficient uncured green strength to stand or to be handled.

1. An insulating refractory composition which is fibre free and comprises a lightweight refractory filler of tamped bulk density no greater than 0.4 g/cc, hollow refractory microspheres and a binder, the binder being water-based or curable at about 100° C. or below, the composition being curable by microwaves and having a cured density of less than 0.45 g/cc.

2. An insulating refractory composition according to claim 1, in which the density of the cured composition is less than 0.40 g/cc.

3. An insulating refractory composition in which the lightweight refractory filler is perlite, calcinated diatomite, expanded vermiculite or Kieselguhr.

4. An insulating refractory composition in which the lightweight refractory filler has a tamped bulk density of 0.1 to 0.2 g/cc.

5. An insulating refractory composition in which the lightweight refractory filler is present in the composition prior to curing in an amount up to 25% by weight.

6. An insulating refractory composition according to claim 5, in which the lightweight refractory filler is present in an amount of from 1 to 15% by weight.

7. An insulating refractory composition according to any preceding claim, in which the hollow refractory microspheres are cenospheres.

8. An insulating refractory composition according to any one of claims 1 to 6, in which the hollow refractory microspheres are of alumina or alumina-silica.

9. An insulating refractory composition according to any preceding claim, in which the hollow refractory microspheres are present in the uncured composition in an amount of up to 95% by weight.

10. An insulating refractory composition according to claim 9, in which the hollow refractory microspheres are present in an amount of from 39 to 87% by weight.

11. An insulating refractory composition according to any preceding claim, in which the binder is an acrylic, vinyl acetate, ethylene-vinyl acetate or vinyl acetate-acrylic ester copolymer emulsion.

12. An insulating refractory composition according to any preceding claim, in which the binder is present in the uncured composition in an amount of up to 32% by weight.

13. An insulating refractory composition according to claim 12, in which the binder is present in an amount of from 4 to 22% by weight.

14. An insulating refractory composition according to any preceding claim, in which the uncured composition contains no more than 20% by weight of liquid.

15. An insulating refractory composition according to claim 14, in which the liquid is present in an amount of from 2 to 17% by weight.

16. An insulating refractory composition according to any preceding claim, in which the cured composition has a residual water content no greater than 0.5% by weight.

17. An insulating refractory composition according to any preceding claim, in which the composition contains up to 0.3% by weight of a dye.

18. An insulating refractory composition according to any preceding claim, in which the composition contains from 0.5 to 6.0% by weight of coal dust.

19. A cured composition according to any preceding claim, shaped to the form of a sleeve, board or disc for use in the feeder cavity of a mould.

20. A method of making a cured, shaped product of refractory composition in which a fibre-free composition comprising a lightweight refractory filler, hollow refractory microspheres and a binder which is water based or curable at 100° C. or below is shaped to a green product and the green product is cured by microwaves.

21. A method according to claim 20, in which the microwave power is from 600 to 850 watts.

22. A method according to claim 20 or 21, in which the cured products are shaped to have a wall section thickness of from 9 to 20 mm and the microwave curing time is from 1 to 5 minutes.

23. A method according to claim 20, 21 or 22, in which the composition is shaped prior to curing by ramming, core-shooting or a jolt/squeeze technique.

24. A method according to any one of claims 20 to 23, in which the composition is cured within the mould in which it has been shaped, the mould being porous.

25. A composition according to claim 1, substantially as hereinbefore described with reference to the Examples.

26. A method of making a cured shaped product according to claim 20, substantially as hereinbefore described with reference to and as shown in the accompanying FIGS. 3, 4 and 5 of the drawings.
